(19) United States
(12) Patent Application Publication
(10) Pub. No.: US 2022/0129914 A1
(43) Pub. Date: Apr. 28, 2022

(54) METHOD FOR VERIFYING PRODUCT AUTHENTICITY AND ESTABLISHING AUTHORIZED PRODUCT DATA WITH FABRIC FEATURES

(71) Applicants: HENG SHENG INVESTMENT LTD., Road Town (VG); TAIWAN FINTECH CORPORATION, Taipei (TW)

(72) Inventors: Chih-Wen LIAO, Taichung (TW); Chu WU, Taichung (TW); Yuh-Jiun LIN, Taipei (TW); Chi-Hang TSAI, Taipei (TW); Han-Chao LEE, Taipei (TW); Ko-Yang WANG, Taipei (TW)

(21) Appl. No.: 17/142,772

(22) Filed: Jan. 6, 2021

(30) Foreign Application Priority Data
Oct. 28, 2020 (TW) 109137426

(51) Int. Cl. G06Q 30/00; G06K 9/00; G06K 9/62; G06K 9/46

(52) U.S. Cl. CPC G06Q 30/0185; G06K 9/00577; G06K 2009/0059; G06K 9/4652; G06K 9/6202; G06K 9/6215

(57) ABSTRACT

The present invention provides a method for verifying a product authenticity with fabric features, comprising steps of receiving at least one fabric partial image and performing image analysis to determine an image optical feature distribution information of an anti-counterfeiting feature, receiving a fabric serial number generated by operation of an input device, and determining whether a fabric is an authorized product by using the fabric serial number or the information. The present invention provides a method for establishing a authorized product data with fabric features, comprising steps of generating at least one fabric image waiting verifying by photographing a part of the fabric with the anti-counterfeiting feature, performing image analysis to generate an image optical distribution feature, recording the image optical distribution feature as an authentic anti-counterfeiting feature information, and storing the information correlated with an authentic fabric serial number to generate an authorized product data.

### FIELD OF THE INVENTION

The invention relates to a method for verifying product authenticity and establishing authorized product data, and more particularly to a method for verifying a product authenticity and establishing an authorized product data with fabric features.

### BACKGROUND OF THE INVENTION

There are many counterfeit products on the market, so brands of various fabrics have developed methods to add anti-counterfeit identification label or logo on fabrics in order to provide consumers with the ability to verify the authenticity of the fabric products they want to buy.

Existing fabrics mostly attach an anti-counterfeiting tag additionally or add an anti-counterfeiting label or logo on the fabric tag. The anti-counterfeiting tag and the anti-counterfeiting label or logo are provided with anti-counterfeiting bar code or laser stamp thereon to achieve an object of anti-counterfeiting. However, conventional anti-counterfeiting tag or anti-counterfeiting label may still be attached on counterfeit products stealthily by unscrupulous manufacturers, which will cause confusion of the genuine product with the counterfeit. Furthermore, since the conventional anti-counterfeiting tag or anti-counterfeiting label is additionally added, it is still possible for the unscrupulous manufacturers to imitate the fabric and then attach recycled or forged anti-counterfeiting tag or anti-counterfeiting label, causing a large quantity of unauthorized fabrics to circulate in the market, and damaging the goodwill of brand owners.

On the other hand, the current method of authenticity identification of fabrics may also be determined by the stitches and textures of the fabric. If a quantity of genuine products provided by the fabric manufacturer exceeds an authorized quantity during the production process, since the stitches and textures of the aforementioned unauthorized fabrics are the same as those of the authorized products, the company will obtain erroneous authentication results when authenticating the unauthorized fabrics.

### SUMMARY OF THE INVENTION

A main object of the invention is to solve the problem that the conventional anti-counterfeiting techniques are easy to be copied, causing the authenticity of a product to be incapable of being verified correctly.

A secondary object of the invention is to solve the problem that a quantity of genuine fabrics provided by manufacturers may exceed an authorized quantity, making it difficult to identify between authorized products and unauthorized fabrics.

In order to achieve the above objects, the invention provides a method for verifying a product authenticity with fabric features, implemented by an electronic device, and the method includes steps of:

receiving at least one fabric partial image and performing image analysis on the at least one fabric partial image to determine a fabric body comprising at least one first yarn loop and an anti-counterfeiting feature composed of a plurality of second yarn loops, and analyzing an image optical feature distribution information from a part of the anti-counterfeiting feature after the anti-counterfeiting feature is determined, wherein at least two sub-yarns which form the plurality of second yarns randomly forms the image optical feature distribution information, and colour of the at least two sub-yarns are not close to each other;

receiving a fabric serial number generated by operation of an input device; and

retrieving the fabric serial number or the image optical feature distribution information to find a authorized product data correlated therewith, the authorized product data including an authorized product serial number and an anti-counterfeiting feature information of an authorized product, which are provided to comparing with the fabric serial number and the image optical feature distribution information; wherein providing an authorized product prompt information if the authorized product serial number and the anti-counterfeiting feature information of the authorized product are matched with the fabric serial number and the image optical feature distribution information; and wherein providing a counterfeit prompt information if the authorized product serial number and the anti-counterfeiting feature information of the authorized product are not matched with the fabric serial number and the image optical feature distribution information.

In one embodiment, the method further comprises photographing a fabric waiting verifying by a camera device to generate the at least one fabric partial image

In one embodiment, the method further comprise receiving the at least one fabric partial image obtained from the fabric waiting verified, and inducting the anti-counterfeiting feature in the at least one fabric partial image via an image similarity analysis.

In one embodiment, the method further comprises obtaining at least two partial feature colour distribution information from the authorized product data, analyzing colour of the image optical feature distribution information to generate at least two feature colour distribution information which are the same as or similar to the at least two partial feature colour distribution information, respectively, and comparing each feature colour distribution information with the partial feature colour distribution information correlated thereto.

In one embodiment, the authorized product data is stored in a cloud server.

In one embodiment, the cloud server is implemented by blockchain storage.

In one embodiment, the anti-counterfeiting feature information of the authorized product includes a planar image optical feature distribution information and a three-dimensional image optical feature distribution information, and the method further comprises receiving a plurality of fabric partial images obtained from the fabric waiting verifying, retrieving the image optical feature distribution information from the anti-counterfeiting feature in the plurality of fabric partial images, and sampling a three-dimensional image optical feature distribution information to be verified for comparing with the three-dimensional image optical feature distribution information.

In one embodiment, the authorized product prompt information includes at least one of a product information, a brand manufacturer, a manufacturing country, a first point-of-sale, a location of an anti-counterfeiting feature, a fabric image of the anti-counterfeiting feature, and the authorized product serial number.

In addition to the foregoing, the invention further provides a method for establishing an authorized product data with fabric features, including steps of:

generating at least one fabric image to be analyzed by photographing a part of a fabric with an anti-counterfeiting feature, wherein the fabric comprises a fabric body comprising at least one first yarn loop and the anti-counterfeiting feature composed of a plurality of second yarn loops, and image optical features of the at least one first yarn loop is not close to image optical features of the plurality of second yarn loops;

performing image analysis on the second yarn loops in the at least one fabric image to generate an image optical distribution feature, wherein the image optical distribution feature is randomly generated by at least two sub-yarns and comprise image optical features not close to each other, respectively; and

recording the image optical distribution feature as an anti-counterfeiting feature information of an authorized product, and storing the anti-counterfeiting feature information in correlation with an authorized product serial number to generate an authorized product data.

In one embodiment, the at least two sub-yarns belong to a same colour hue in a natural colour system and are separated by at least three colour levels apart

In one embodiment, colours of the at least two sub-yarns are not absolute white, absolute black, or gray mixed with absolute white and absolute black in proportion.

In one embodiment, the at least two sub-yarns are not reflective yarns.

In one embodiment, the authorized product serial number is a serial number or the authorized product serial number is defined by a brand owner.

In one embodiment, the authorized product data includes a first point-of-sale data, and the first point-of-sale data is generated after the fabric is first sold at a sales location.

In one embodiment, the method further comprises photographing a part of the fabric with the anti-counterfeiting feature to generate a plurality of fabric images waiting verifying in different angles, sampling the plurality of fabric images waiting verifying to generate a planar image optical feature distribution information and a three-dimensional image optical feature distribution information, and recording the planar image optical feature distribution information and the three-dimensional image optical feature distribution information in the anti-counterfeiting feature information.

In one embodiment, the method further comprises analyzing colour of the image optical distribution feature to generate at least two partial feature colour distribution information, and recording the at least two partial feature colour distribution information in the authorized product data.

According to the foregoing implementation of the invention, compared with the prior art, the invention has the following features: the anti-counterfeiting feature is directly formed with on the fabric, so when verifying the authenticity of a product, the invention determines whether the fabric is an authorized product based on the image optical feature distribution information randomly generated by the at least two sub-yarns and the fabric serial number. In addition, when the invention establishes the authorized product data, since the fabric body is simultaneously generated with the anti-counterfeiting feature during a weaving process of the fabric, when the authorized fabrics with a quantity exceeding a quantity of genuine products circulate on the market, the brand owner would not provide the fabric serial numbers for the fabrics, so that subsequent users can identify whether the fabrics are authorized by the brand owner.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flowchart of a first embodiment of a method for verifying a product authenticity with fabric features according to the invention;

FIG. 2 is a schematic diagram of a fabric of the first embodiment of the method for verifying a product authenticity with the fabric features according to the invention;

FIG. 3 is a block diagram of an electronic device of the first embodiment of the method for verifying a product authenticity with the fabric features according to the invention;

FIG. 4 is a flowchart of a second embodiment of the method for verifying a product authenticity with the fabric features according to the invention;

FIG. 5 is a flowchart of a third embodiment of the method for verifying a product authenticity with the fabric features according to the invention;

FIG. 6 is a flowchart of a fourth embodiment of the method for verifying a product authenticity with the fabric features according to the invention;

FIG. 7 is a schematic diagram of a fabric image to be analyzed according to an embodiment of the invention;

FIG. 8 is a schematic diagram of an image optical feature distribution information of an authorized product according to an embodiment of the invention;

FIG. 9 is a first schematic diagram of a partial feature colour distribution information according to an embodiment of the invention;

FIG. 10 is a second schematic diagram of the partial feature colour distribution information according to an embodiment of the invention;

FIG. 11 is a schematic diagram of a partial image of a fabric according to an embodiment of the invention;

FIG. 12 is a schematic diagram of the image optical feature distribution information according to an embodiment of the invention;

FIG. 13 is a first schematic diagram of a feature colour distribution information according to an embodiment of the invention;

FIG. 14 is a second schematic diagram of the feature colour distribution information according to an embodiment of the invention;

FIG. 15 is a first schematic diagram of a distribution difference information according to an embodiment of the invention;

FIG. 16 is a second schematic diagram of the distribution difference information according to an embodiment of the invention;

FIG. 17 is a schematic diagram of the fabric image to be analyzed according to another embodiment of the invention;

FIG. 18 is a schematic diagram of an image optical feature distribution information of an authorized product according to another embodiment of the invention;

FIG. 19 is a first schematic diagram of a partial feature colour distribution information according to another embodiment of the invention;

FIG. 20 is a second schematic diagram of the partial feature colour distribution information according to another embodiment of the invention;

FIG. 21 is a schematic diagram of a partial image of a fabric according to another embodiment of the invention;

FIG. 22 is a schematic diagram of the image optical feature distribution information according to another embodiment of the invention;

FIG. 23 is a first schematic diagram of the feature colour distribution information according to another embodiment of the invention;

FIG. 24 is a second schematic diagram of the feature colour distribution information according to another embodiment of the invention;

FIG. 25 is a first schematic diagram of the distribution difference information according to another embodiment of the invention;

FIG. 26 is a second schematic diagram of the distribution difference information according to another embodiment of the invention;

FIG. 27 is a schematic diagram of steps of a fifth embodiment of the method for verifying a product authenticity with the fabric features according to the invention;

FIG. 28 is a schematic diagram of steps of a first embodiment of a method for establishing an authorized product data with fabric features according to the invention;

FIG. 29 is a schematic diagram of steps of a second embodiment of the method for establishing the authorized product data with the fabric features according to the invention; and

FIG. 30 is a schematic diagram of steps of a third embodiment of the method for establishing the authorized product data with the fabric features according to the invention.

### DETAILED DESCRIPTION OF THE PREFERRED EMBODIMENTS

The detailed description and technical content of the invention are described below with reference to the drawings.

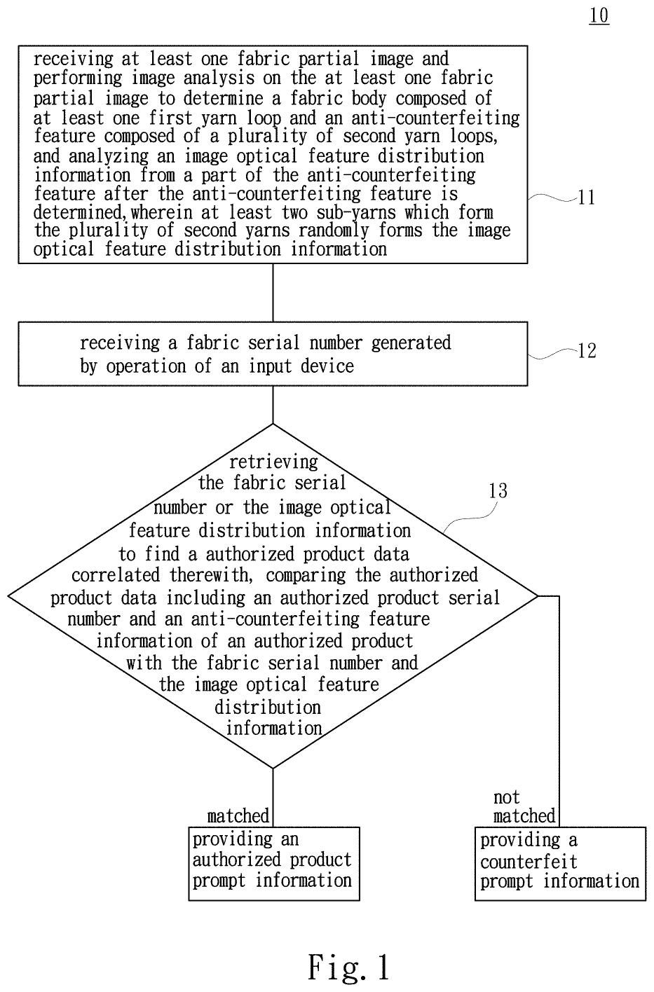

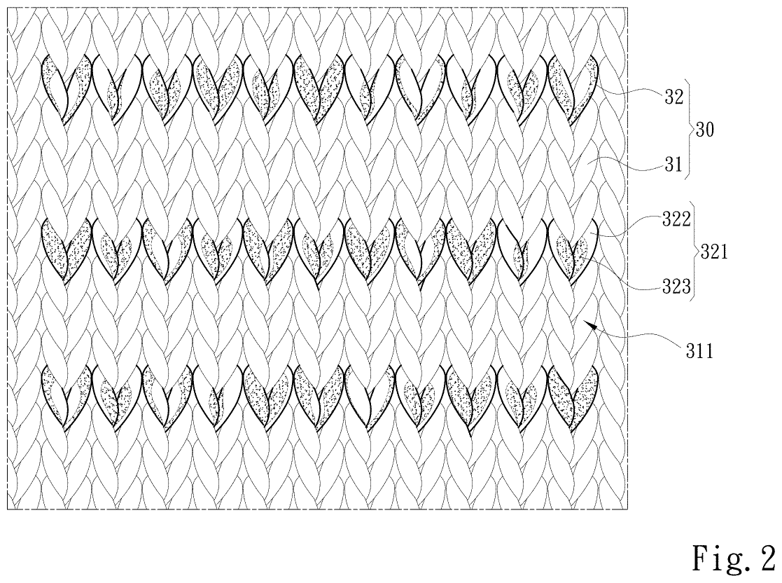

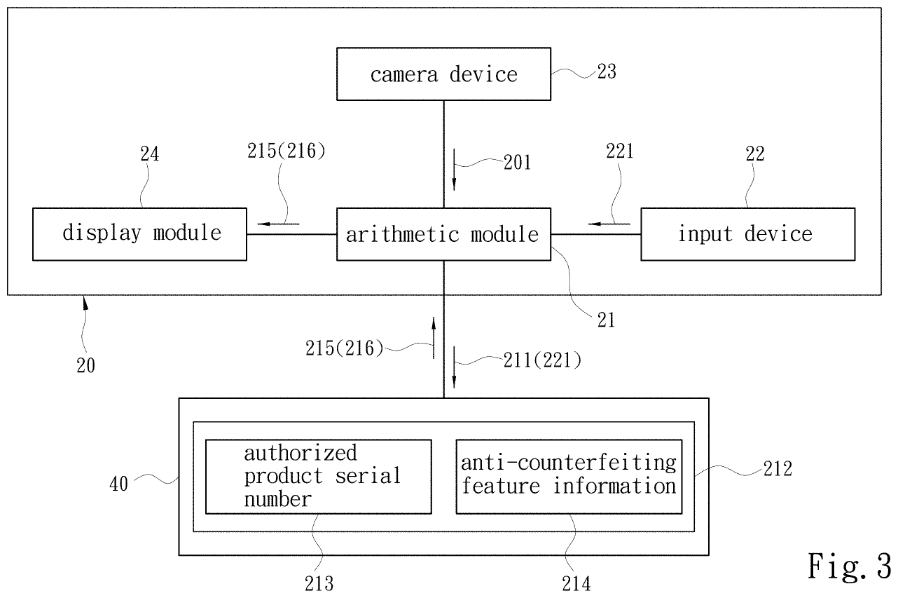

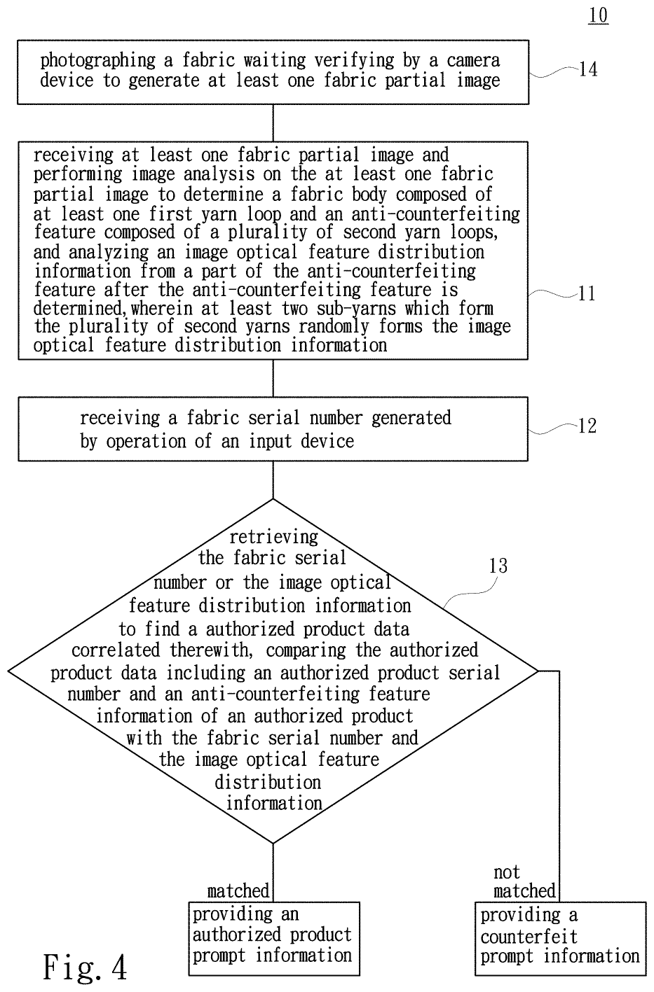

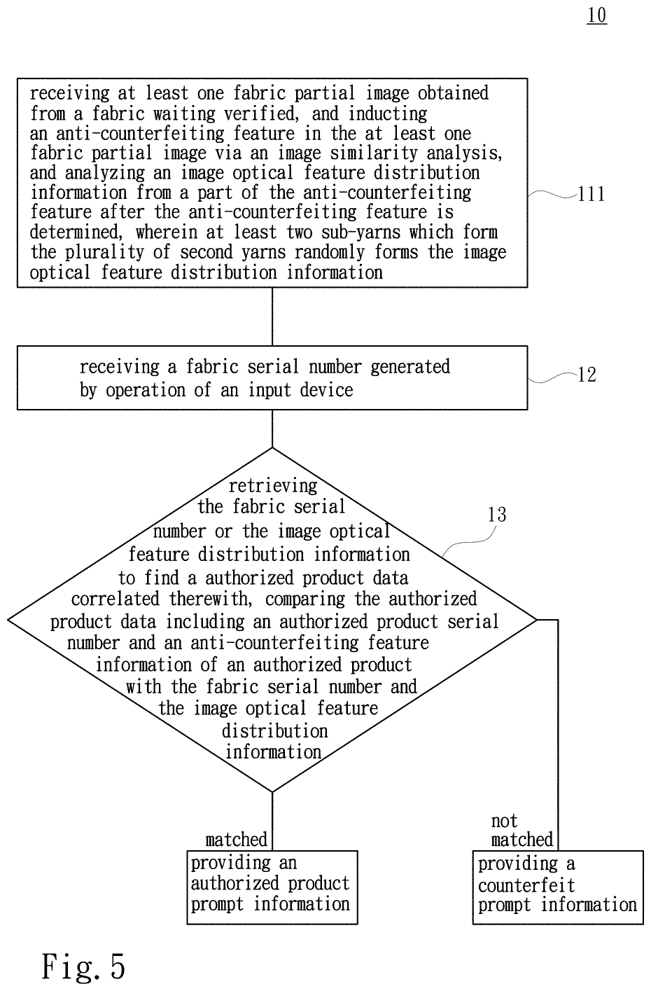

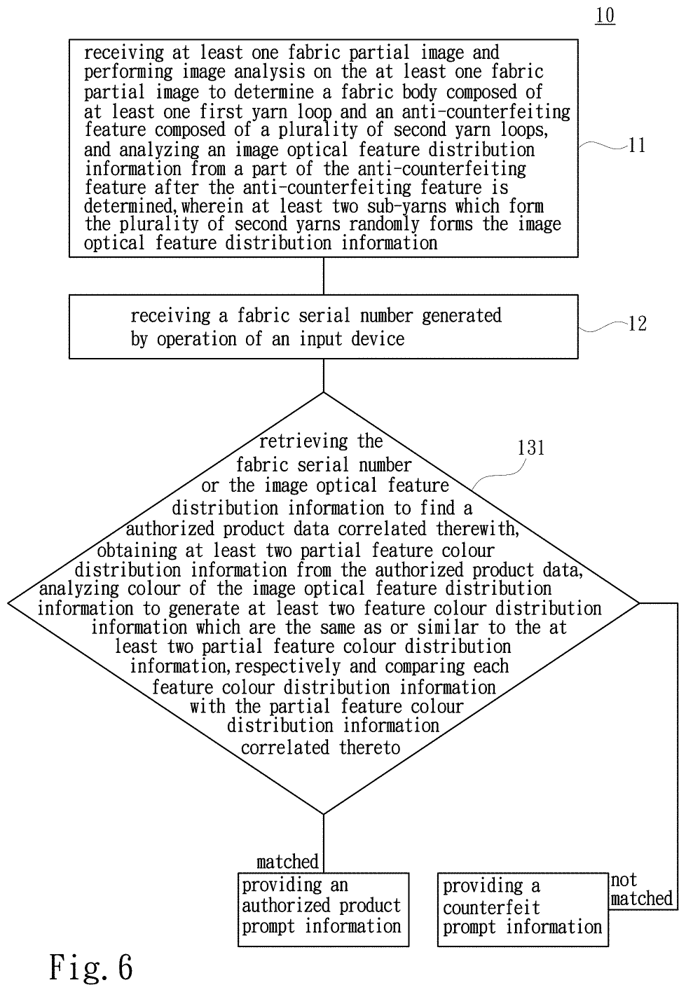

Please refer to FIG. 1, FIG. 2, FIG. 3, FIG. 4, FIG. 5, and FIG. 6, the invention provides a method 10 for verifying a product authenticity with fabric features. The method 10 is implemented by an electronic device 20 to determine an authenticity of a fabric 30. Before describing the method 10 of the invention, the fabric 30 of the invention will be described first. The fabric 30 comprises a fabric body 31 comprising at least one first yarn loop 311, and an anti-counterfeiting feature 32 composed of a plurality of second yarn loops 321, wherein the fabric body 31 is connected to the anti-counterfeiting feature 32, that is, the anti-counterfeiting feature 32 of the invention is directly formed on the fabric 30 instead of being connected to the fabric 30 by an additional structure such as a conventional tag. Furthermore, image optical features of the fabric body 31 and the anti-counterfeiting feature 32 are not close to each other, that is, a color of the first yarn loop 311 is not close to a colour of the second yarn loops 321. In an embodiment, the first yarn loop 311 and the second yarn loops 321 belong to different colour hues in an Natural Colour System (NCS), and a colour hue angle greater than or equal to 30 degrees is formed between the two colour hues. For example, if the first yarn loop 311 is selected to be in Y10R hue, the selection of colour hues for the second yarn loops 321 is excluded from the colour hue angle between Y10R and Y50R, or the colour hue angle between Y10R and G70Y. In addition, if the first yarn loop 311 and the second yarn loops 321 belong to a same colour hue in the NCS, the first yarn loop 311 and the second yarn loops 321 need to be separated by at least three colour levels. In an example that the first yarn loop 311 and the second yarn loops 321 belong to Y90R hue, if a colour level of the first yarn loop 311 is selected to be in S1050 colour level of an NCS colour triangle defined by an NCS colour circle, a colour level of the second yarn loops 321 can be in S1020 colour level or S6030 colour level. That is, a colour code of the first yarn loop 311 is S1050-Y90R, and a colour code of the second yarn loop 321 is S1020-Y90R or Y6030-Y90R.

Further, the method 10 for verifying a product authenticity with the fabric features includes following steps of:

step 11: receiving at least one fabric partial image 201 and performing image analysis on the at least one fabric partial image 201 to determine a fabric body 31 comprising at least one first yarn loop 311 and an anti-counterfeiting feature 32 composed of a plurality of second yarn loops 321, and analyzing an image optical feature distribution information 211 from a part of the anti-counterfeiting feature 32 after the anti-counterfeiting feature 32 is determined, wherein at least two sub-yarns 322, 323 which form the plurality of second yarn loops 321 randomly forms the image optical feature distribution information 211 and the at least two sub-yarns 322, 323 comprise image optical features not close to each other, respectively;

step 12: receiving a fabric serial number 221 generated by operation of an input device 22; and

step 13: retrieving the fabric serial number 221 or the image optical feature distribution information 211 to find a authorized product data 212 correlated therewith, the authorized product data 212 including an authorized product serial number 213 and an anti-counterfeiting feature information 214 of the authorized product, which are provided to comparing with the fabric serial number 221 and the image optical feature distribution information 211; wherein providing an authorized product prompt information if the authorized product serial number 213 and the anti-counterfeiting feature information 214 of the authorized product are matched with the fabric serial number 221 and the image optical feature distribution information 211; and wherein providing a counterfeit prompt information if the authorized product serial number 213 and the anti-counterfeiting feature information 214 of the authorized product are not matched with the fabric serial number 221 and the image optical feature distribution information 211.

The method 10 is specifically described as follows. In step 11, an arithmetic module 21 of the electronic device 20 receives the at least one fabric partial image 201 of the fabric 30, and performs an image analysis on the at least one fabric partial image 201. In an embodiment, the arithmetic module 21 analyzes a colour distribution of the at least one fabric partial image 201, patterns of the anti-counterfeiting feature 32, or differences of special wavelength light-absorption properties between the fabric body 31 and the anti-counterfeiting feature 32 to determine and distinguish between the fabric body 31 and the anti-counterfeiting feature 32. And the arithmetic module 21 analyzes the image optical feature distribution information 211 from a part of the anti-counterfeiting feature 32 after the anti-counterfeiting feature 32 is determined. In addition, the image optical feature distribution information 211 is randomly generated based on the two sub-yarns 322, 323 composing the second yarn loop 321, and the image optical feature distribution information 211 provides colour distribution on one side surface of the second yarn loop 321 revealed by the two sub-yarns 322, 323. In an embodiment shown in FIG. 2, dotted pattern in the figure represents a colour of one of the two sub-yarns 323(322), and blank represents a colour of the other one of the two sub-yarns 322(323). One of the two sub-yarns 322(323) is mainly distributed at an outer edge of the second yarn loop 321, and the other one of the two sub-yarns 323(322) is mainly distributed at an inner edge of the second yarn loop 321. The two sub-yarns 322, 323 respectively occupy 50% of a surface of the second yarn loop 321. Accordingly, the image optical feature distribution information 211 includes distribution locations and distribution area sizes of the two sub-yarns 322, 323.

Afterwards, proceed to step 12 to receive the fabric serial number 221 generated by operation of the input device 22, wherein the input device 22 is defined according to types of the electronic device 20. For example, if the electronic device 20 is a notebook computer, the input device 22 is a keyboard of the notebook computer; or if the electronic device 20 is a smart phone, the input device 22 is a touch screen of the smart phone. Then, proceed to step 13, the arithmetic module 21 retrieves a authorized product data 212 correlating with the fabric serial number 221 or the image optical feature distribution information 211, compares the fabric serial number 221 with the authorized product serial number 213 recorded in the authorized product data 212, and also compares the image optical feature distribution information 211 with the anti-counterfeiting feature information 214 correlated with the authorized product serial number 213. If the comparison result matches, the arithmetic module 21 generates the authorized product prompt information 215 transmitting to a display module 24. If the comparison result does not match, the arithmetic module 21 generates the counterfeit prompt information 216 transmitting to the display module 24. The display module 24 depicted in the drawings herein can be a display screen of the electronic device 20, or a display device externally connected to the electronic device 20. In addition, the authorized product prompt information 215 and the counterfeit prompt information 216 described herein can be a prompt sound, a prompt pattern, or a text information, respectively. In one embodiment, the authorized product prompt information 215 includes at least one of a product information, a brand manufacturer, a manufacturing country, a first point-of-sale, a location of the anti-counterfeiting feature 32, a fabric image of the anti-counterfeiting feature 32, and the authorized product serial number 213. The product information refers to product-related information of the fabric 30 that is authorized to be manufactured and sold. For example, the product information includes an article number or a batch number of the fabric 30.

The invention directly forms the anti-counterfeiting feature 32 on the fabric and determines an authenticity of the fabric 30 through random colour changes on a side surface of the second yarn loop 321, instead of conventionally attaching additional anti-counterfeiting tags or pasting anti-counterfeiting labels thereon. Therefore, the invention is able to eradicate the fabric 30 imitated by unscrupulous manufacturers, and also prevent the manufacturers from providing an unauthorized amount of the fabric 30 exceeding an authorized quantity into the market during a production process.

In one embodiment, please refer to FIG. 1, FIG. 2, FIG. 3, and FIG. 4. The electronic device 20 further includes a camera device 23 connected to the arithmetic module 21. The method 10 further includes step 14: photographing a fabric waiting verifying by the camera device 23 to generate the at least one fabric partial image 201. In another embodiment, please refer to FIG. 5. Step 11 of the method 10 further includes a sub-step 111: receiving the at least one fabric partial image 201 obtained from the fabric waiting verifying, and inducting the anti-counterfeiting feature 32 in the at least one fabric partial image 201 via an image similarity analysis. Specifically, the arithmetic module 21 performs similarity statistics on samples captured from the fabric waiting verifying. If a difference of the samples is approximate, the samples are determined as the fabric body 31; if the difference of the samples is not approximate, the samples are determined that containing the fabric body 31 and the anti-counterfeiting feature 32 together.

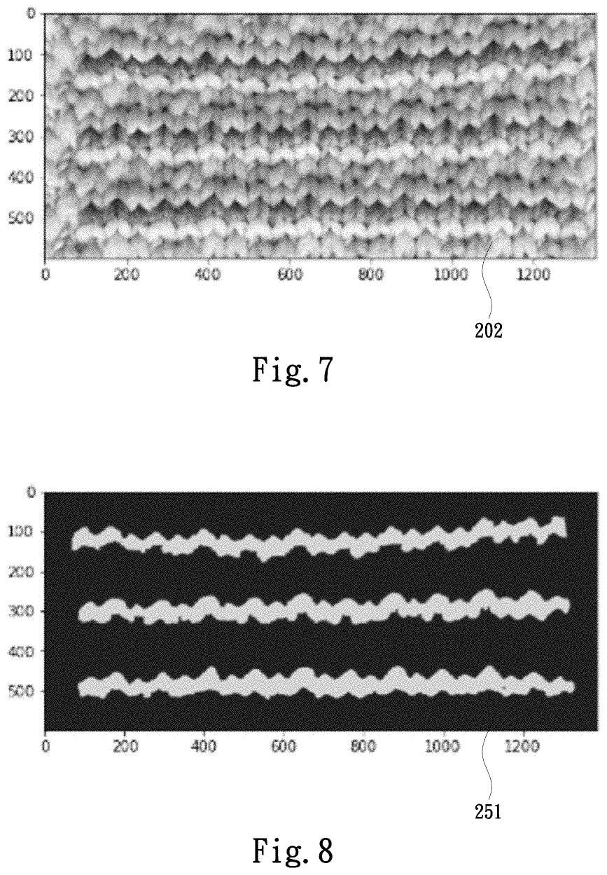

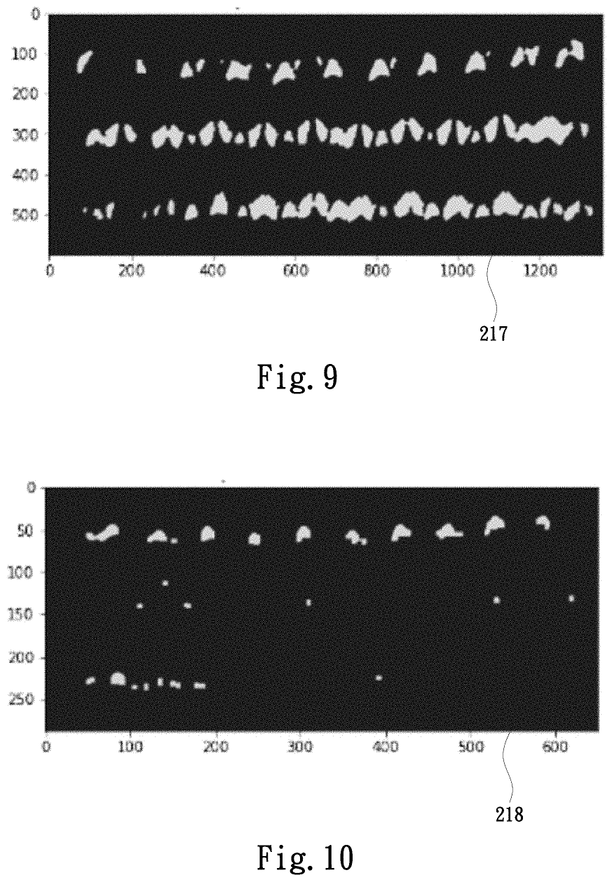

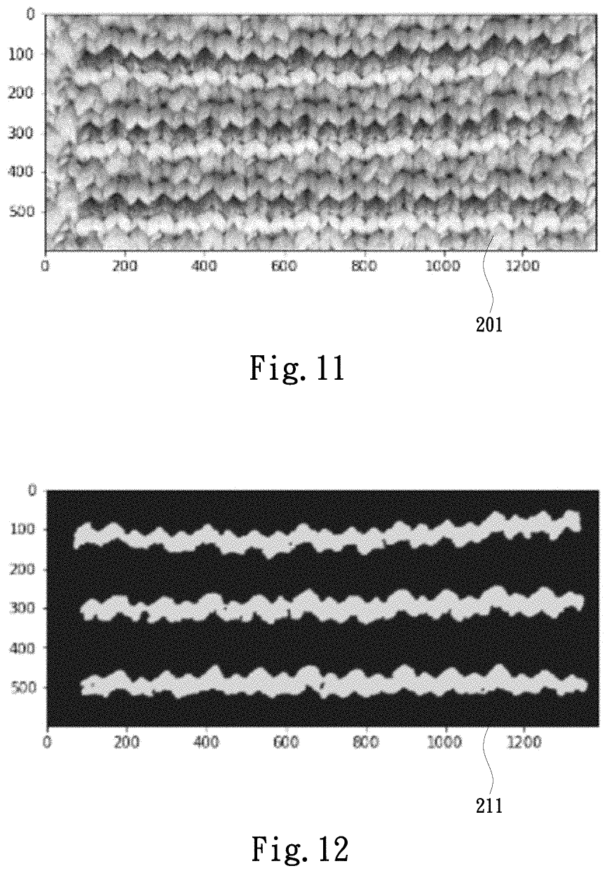

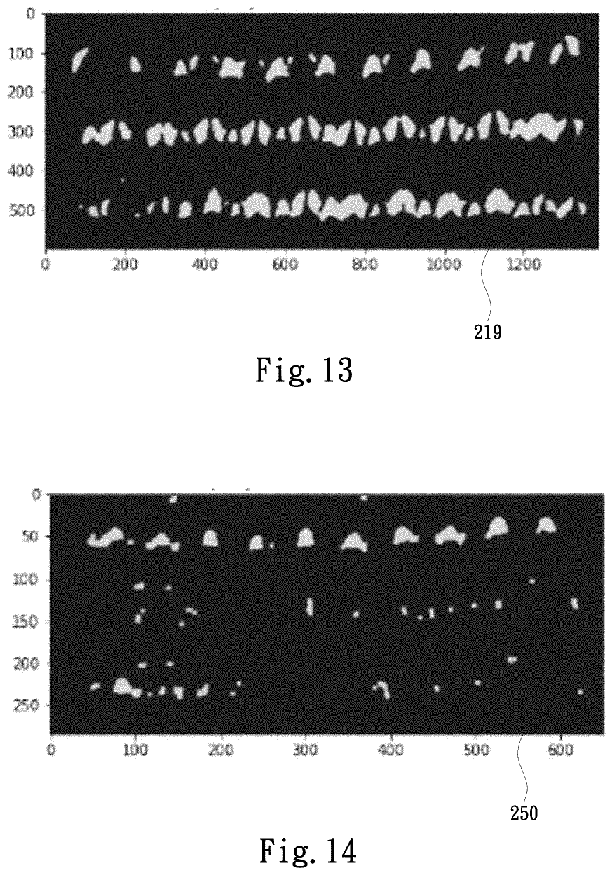

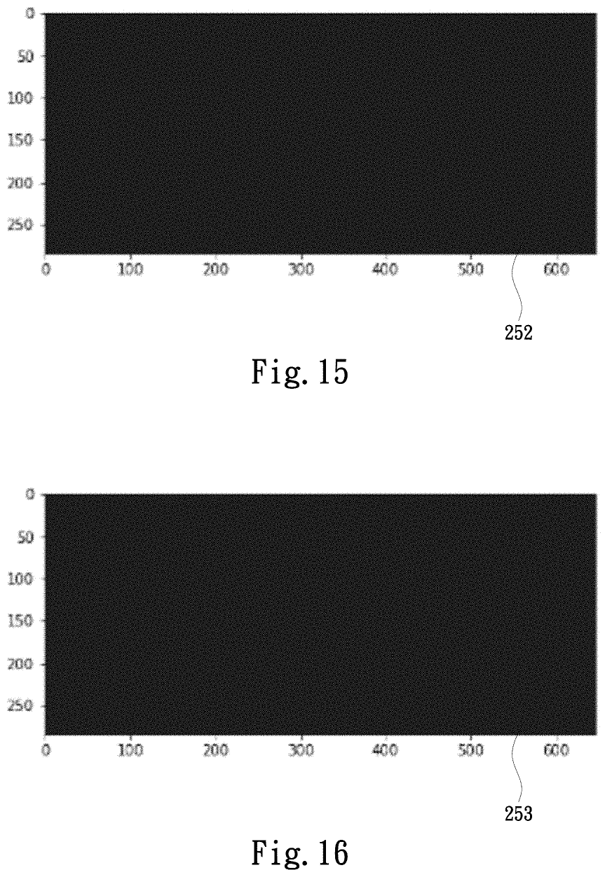

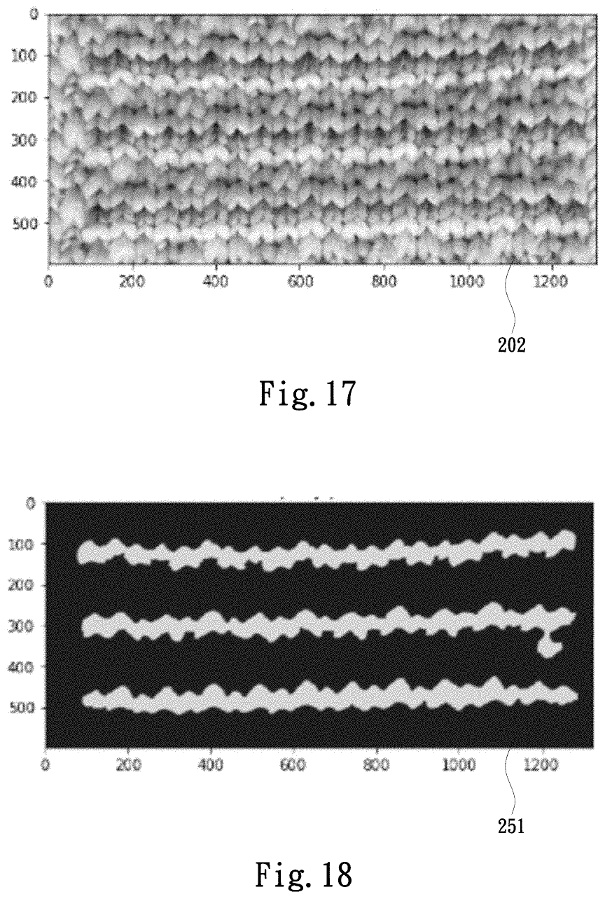

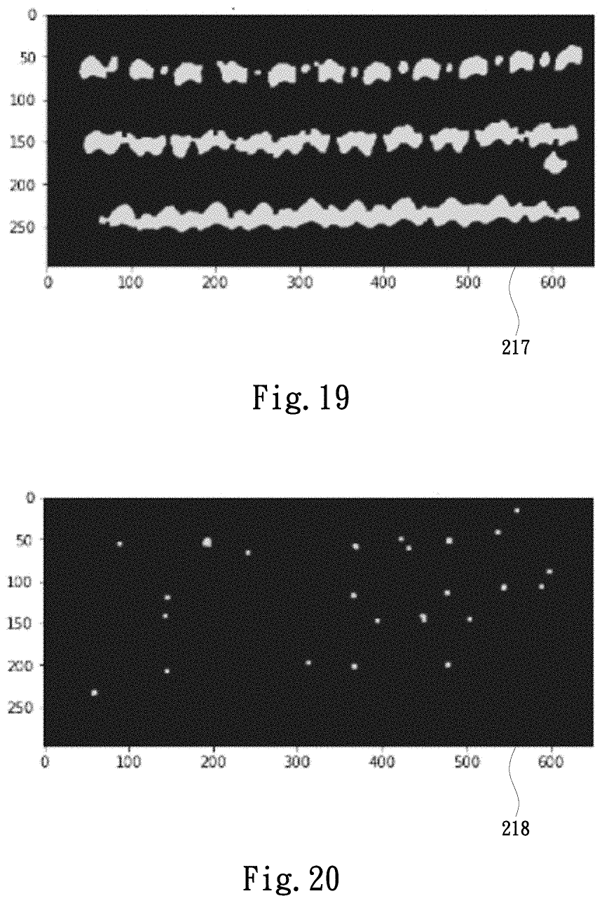

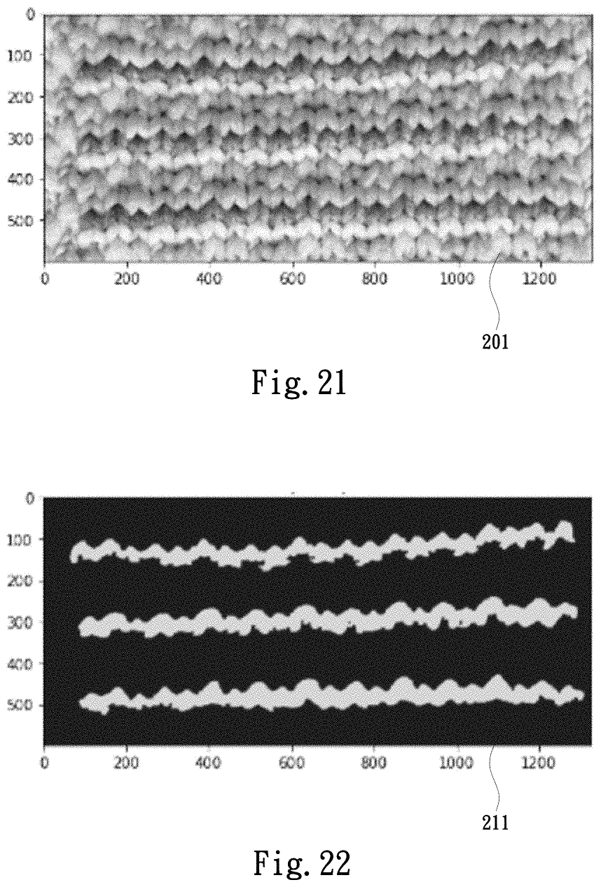

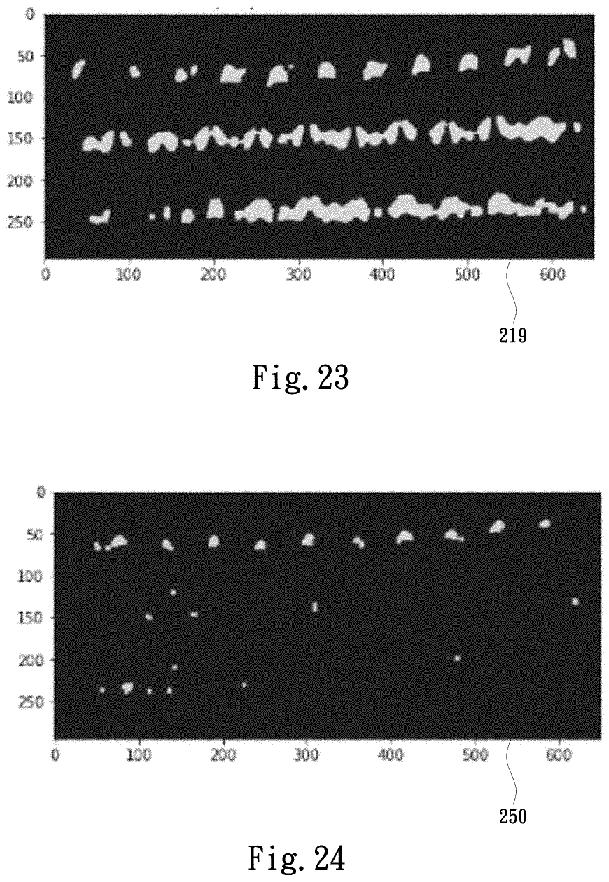

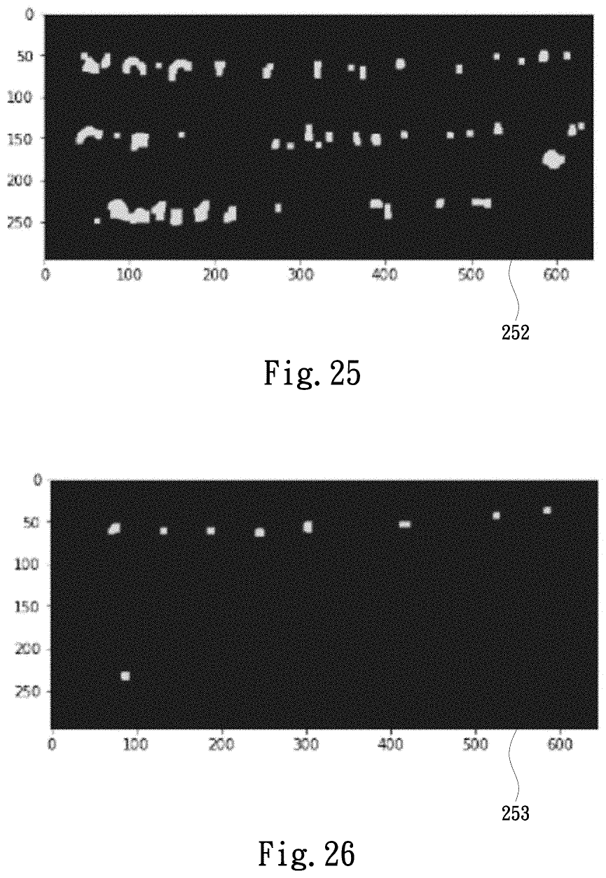

In one embodiment, please refer to FIG. 3, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, and FIG. 26. Step 13 of the method 10 further includes a sub-step 131: obtaining at least two partial feature colour distribution information 217, 218 from the authorized product data 212, analyzing colour of the image optical feature distribution information 211 to generate at least two feature colour distribution information 219, 250 which are the same as or similar to the at least two partial feature colour distribution information 217, 218, respectively, and comparing each feature colour distribution information 219 (250) with the partial feature colour distribution information 217 (218) correlated thereto. For the convenience of description, it is assumed that the anti-counterfeiting feature 32 is composed of a red sub-yarn 322 and a green sub-yarn 323. The arithmetic module 21 retrieves the at least two partial feature colour distribution information 217, 218 from the authorized product data 212. The at least two partial feature colour distribution information 217, 218 can be stored in a cloud server 40 in advance and can be retrieved by the arithmetic module 21. In addition, the partial feature colour distribution information 217 provides a distribution of a red sub-yarn on an anti-counterfeiting feature of an authorized product, and the partial feature colour distribution information 218 provides a distribution of a green sub-yarn on the anti-counterfeiting feature of the authorized product, and combination of the at least two partial feature colour distribution information 217, 218 is an image optical distribution feature 251 representing the anti-counterfeiting feature of the authorized product. Then, the arithmetic module 21 analyzes colour of the image optical feature distribution information 211 and generates the at least two feature colour distribution information 219, 250. The feature colour distribution information 219 provides a distribution of the red sub-yarn 322 on the anti-counterfeiting feature 32, and the feature colour distribution information 250 provides a distribution of the green sub-yarn 323. In addition, sampling colour of each of the feature colour distribution information 219 (250) is the same as or similar to sampling colours of one of the partial feature colour distribution information 217 (218). Further, the arithmetic module 21 compares the feature colour distribution information 219 with the correlated partial feature colour distribution information 217 and generates a distribution difference information 252 based on the red sub-yarn 322. The arithmetic module 21 also compares the feature colour distribution information 250 with the correlated partial feature colour distribution information 218 and generates a distribution difference information 253 based on the green sub-yarn 323. In view of FIG. 15 and FIG. 16, no difference marks are indicated on the two distribution difference information 252, 253, which represents that there is no difference between the feature colour distribution information 219 and the correlated partial feature colour distribution information 217; and there is no difference between the feature colour distribution information 250 and the correlated partial feature colour distribution information 218. That is, the fabric 30 is the same as the authorized product. In contrast, as shown in FIG. 25 and FIG. 26, there are difference marks indicated on the two distribution difference information 252, 253, which represents that the fabric 30 is different from the authorized product. In one embodiment, the arithmetic module 21 performs statistical analysis based on the distribution difference information 252 and the distribution difference information 253. If a difference value between the image optical distribution feature 251 and the image optical feature distribution information 211 is greater than or equal to a threshold value, it is determined that the fabric 30 is different from the authorized product, and the counterfeit prompt information 216 is prompted. If a difference value is less than the threshold value, the fabric 30 is determined to be the same as the authorized product and the authorized product prompt information 215 is prompted. In addition, calculation and determination formula of the aforementioned difference value are exemplified as follows:

$$D i s ( T , Q ) = \frac{1}{{N}_{pixel}} {\sum }_{color ∈ C} XOR ( {T}_{c o lor} , {Q}_{color} ) and , \\ Match ( T , Q ) = \{ \begin{matrix}true , Di s ( T , Q ) < {D}_{t h r e s h o l d} \\ false , Di s ( T , Q ) \geq {D}_{t h r e s h o l d}\end{matrix}$$

Wherein T represents one of the partial feature colour distribution information 217 (218), Q represents one of the feature colour distribution information 219 (250), and C represents a colour group of the fabric 30 (in this embodiment, C={red,green}), Nₚᵢₓₑₗ represents a total number of pixels of the partial feature colour distribution information 217, 218 and the feature colour distribution information 219, 250, and D_{threshold} represents the threshold value.

On the other hand, in one embodiment, the electronic device 20 is connected to the cloud server 40, and the authorized product data 212 is stored in the cloud server 40. Besides, the fabric serial number 221 or the image optical feature distribution information 211 is applied as an index for the arithmetic module 21 retrieving the authorized product data 212 correlated with the fabric serial number 221 or the image optical feature distribution information 211 from the cloud server 40. In addition, the cloud server 40 is implemented by blockchain storage to encrypt the authorized product data 212. In an embodiment, the cloud server 40 attaches a timestamp to the authorized product data 212 or store the authorized product data 212 by an encrypted method. The aforementioned encryption method can be implemented by adding a hash value to the authorized product data 212 or by other methods. Accordingly, the invention ensures that the authorized product data 212 cannot be tampered after being written into the cloud server 40 by a distributed computing architecture, such as a blockchain, thereby providing confidentiality and avoiding being tampered.

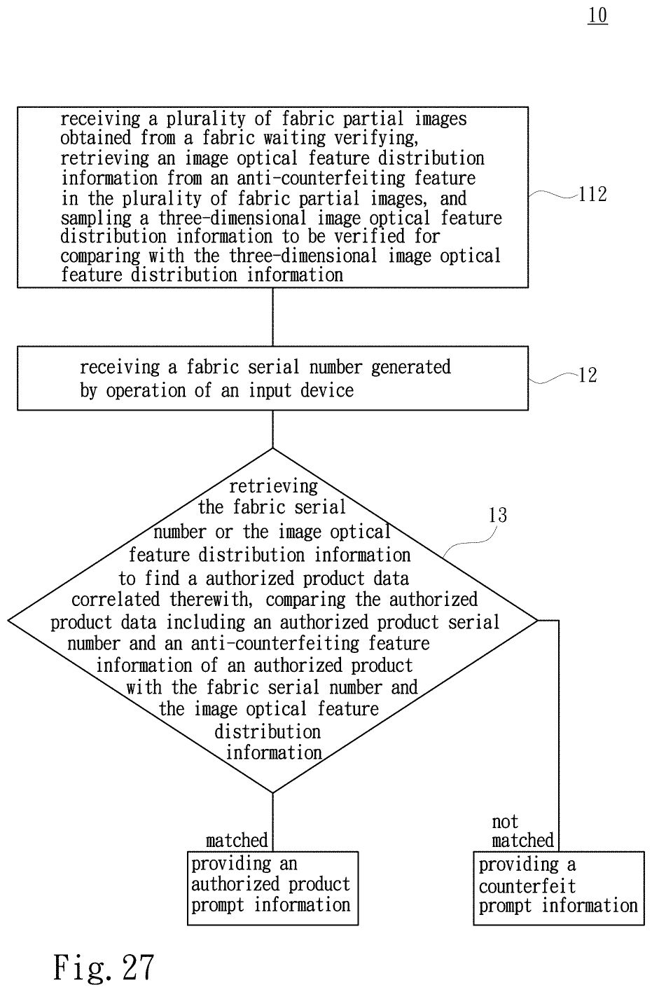

On the other hand, please refer to FIG. 27; in one embodiment, the anti-counterfeiting feature information 214 of the authorized product includes a planar image optical feature distribution information and a three-dimensional image optical feature distribution information so as to enhance a strength of the invention to verify an authenticity of the fabric 30. Also, step 11 of the method 10 further includes a sub-step 112: receiving a plurality of fabric partial images 201 obtained from the fabric waiting verifying, retrieving the image optical feature distribution information 211 from the anti-counterfeiting feature 32 in the plurality of fabric partial images 201, and sampling a three-dimensional image optical feature distribution information to be verified for comparing with the three-dimensional image optical feature distribution information. Specifically, a planar image optical feature distribution information is a planar image generated based on the fabric 30, and the planar image expresses the image optical feature distribution information 211 of the fabric 30 in a two-dimensional manner. The three-dimensional image optical feature distribution information expresses the image optical feature distribution information 211 of the fabric 30 in a in a three-dimensional manner based on the fabric 30. In addition, the three-dimensional image optical feature distribution information is provided for the arithmetic module 21 to identify a colour distribution of the at least two sub-yarns 322, 323 of the fabric 30 under different three-dimensional angles to sample the three-dimensional image optical feature distribution information to be verified; in this way, the arithmetic module 21 is capable of strengthening verification of an authenticity of the fabric 30.

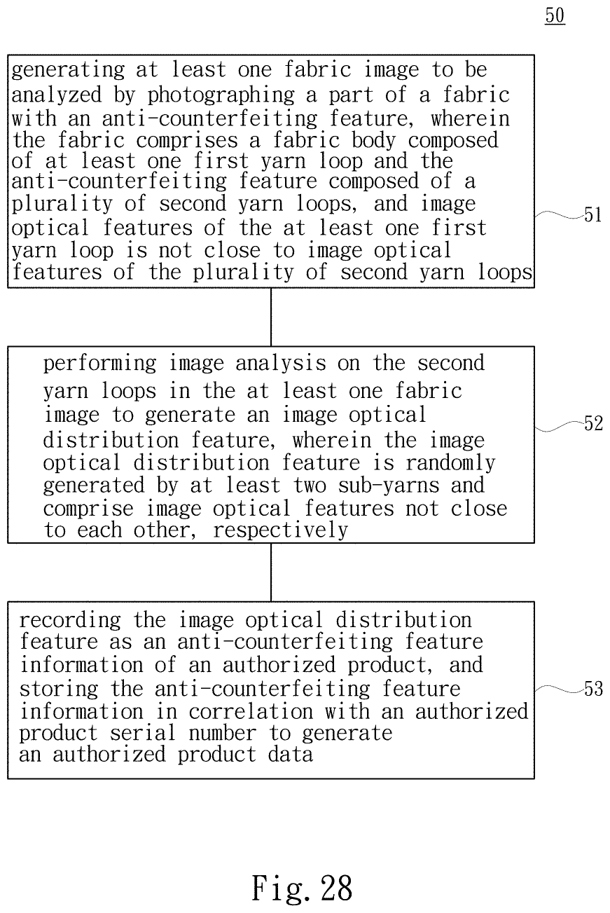

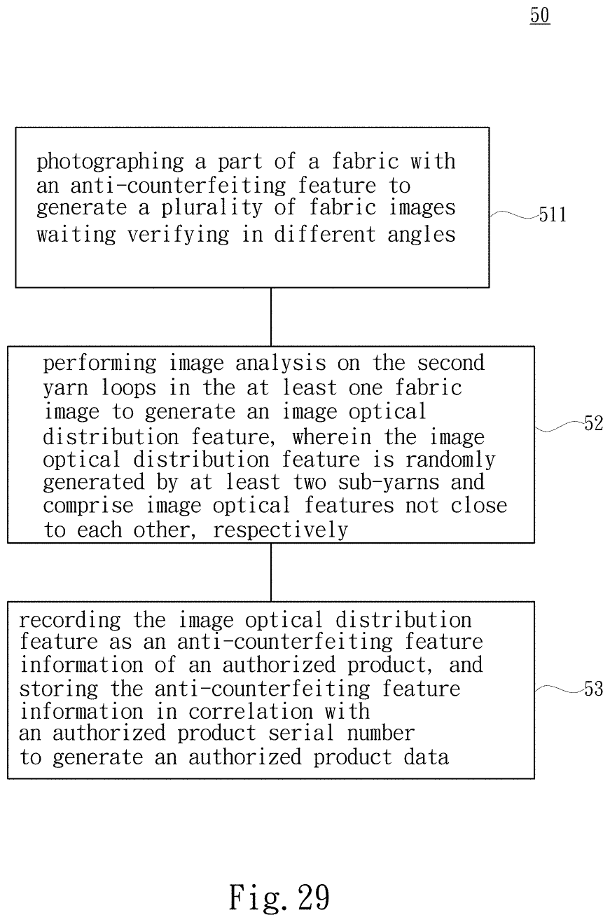

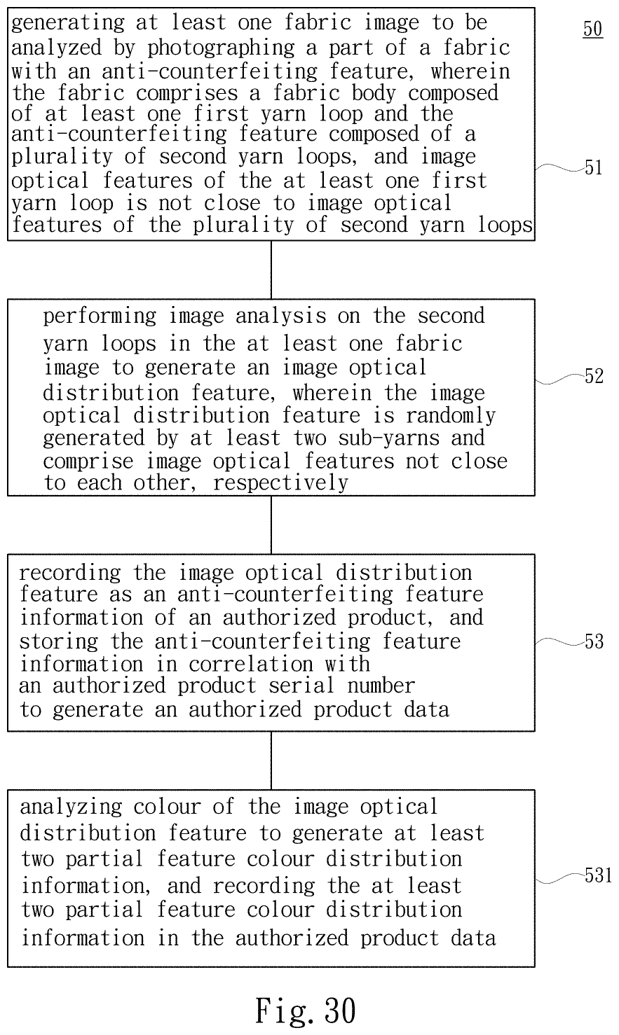

Please refer to FIG. 2, FIG. 28, FIG. 29, and FIG. 30. The invention further provides a method 50 for establishing an authorized product data with fabric features. The method 50 includes following steps of:

step 51: generating at least one fabric image 202 to be analyzed by photographing a part of the fabric 30 with the anti-counterfeiting feature 32. The fabric 30 comprises the fabric body 31 comprising the at least one first yarn loop 311 and the anti-counterfeiting feature 32 composed of the second yarn loops 321, wherein image optical features of the at least one first yarn loops 311 is not close to image optical features of each of the second yarn loops 321;

step 52: performing image analysis on the second yarn loops 321 in the at least one fabric image 202 to generate the image optical distribution feature 251, wherein the image optical distribution feature 251 is randomly generated by the at least two sub-yarns 322, 323 which form the plurality of second yarn loops 321 and comprise image optical features not close to each other, respectively; and

step 53: recording the image optical distribution feature 251 as the anti-counterfeiting feature information 214 of the authorized product, and storing the anti-counterfeiting feature information 214 in correlation with the authorized product serial number 213 to generate the authorized product data 212.

The method 50 is described in detail. Step 51 is performed to photograph a part of the fabric 30 with the anti-counterfeiting feature 32 to generate the at least one fabric image 202 waiting verifying. Then, step 52 is proceeded to perform the image analysis on the second yarn loops 321 in the at least one fabric image 202 to generate the image optical distribution feature 251. Specifically, the image optical distribution feature 251 is generated by each the second yarn loop 321 of the at least two sub-yarns 322, 323. Since the at least two sub-yarns 322, 323 are twisted to form the second yarn loops 321 in a random manner, patterns of the at least two sub-yarns 322, 323 are randomly appeared on a surface of each of the second yarn loops 321. Furthermore, since image optical features of the at least two sub-yarns 322, 323 are not similar, the at least two sub-yarns 322, 323 are clearly distinguished on each of the second yarn loops 321. In detail, if the at least two sub-yarns 322, 323 belong to different colour hues in the natural colour system, a colour hue angle between the two colour hues is greater than or equal to 30 degrees. If the at least two sub-yarns 322, 323 belong to a same colour hue, the at least two sub-yarns 322, 323 are separated by at least three colour levels. Further, step 53 is proceeded to record the image optical distribution feature 251 as the anti-counterfeiting feature information 214 of the authorized product, and to store the anti-counterfeiting feature information 214 in correlation with the authorized product serial number 213 so as to complete the authorized product data 212. When the anti-counterfeiting feature information 214 is retrieved, the authorized product serial number 213 correlated to the anti-counterfeiting feature information 214 in the authorized product data 212 is retrieved together; or when the authorized product serial number 213 is retrieved, the anti-counterfeiting feature information 214 correlated with the authorized product serial number 213 in the authorized product data 212 is retrieved together.

In one embodiment, colours of the at least two sub-yarns 322, 323 are not absolute black, so as to prevent the at least two sub-yarns 322, 323 from absorbing light and being incapable of generating the fabric image 202 to be analyzed when the anti-counterfeiting feature 32 is photographed. In addition, in order to prevent a case where the two sub-yarns 322, 323 generate a large amount of reflection of light during an image capturing process and the two sub-yarns 322, 323 cannot be identified by the arithmetic module 21, the two sub-yarns 322, 323 are not reflective yarns or metal yarns that produce a large amount of reflective effects. In a similar way, since white produces a large amount of reflection of light after being projected by light, the two sub-yarns 322, 323 are not absolute white or gray mixed with absolute white and absolute black in proportion.

In one embodiment, the authorized product serial number 213 is a serial number or the authorized product serial number 213 is defined by a brand owner, wherein any two of the serial numbers are not repeated. For example, the brand owner can define the authorized product serial number 213 based on production information of the fabric 30; or the brand owner can define the authorized product serial number 213 based on an article number or a batch number of the fabric 30. In addition, in one embodiment, the authorized product data 212 further includes a first point-of-sale data which is generated after the fabric 30 is first sold at a sales location, and the first point-of-sale data provides information of a sales location of a store where the fabric 30 is first sold. For example, the first point-of-sale data provides store name and address of the sales location where sells the fabric 30.

In one embodiment, step 53 of the method 50 further includes sub-step 531: analyzing colour of the image optical distribution feature 251 to generate the at least two partial feature colour distribution information 217, 218, and recording the at least two partial feature colour distribution information 217, 218 in the authorized product data 212. As shown in FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, and FIG. 26, the anti-counterfeiting feature 32 is composed of the red sub-yarn 322 and the green sub-yarn 323. In sub-step 531, colour difference of the image optical distribution feature 251 is analyzed, and a distribution of the red sub-yarn 322 and a distribution of the green sub-yarn 323 are recorded in the at least two partial feature colour distribution information 217, 218, respectively. Then, the at least two partial feature colour distribution information 217, 218 are recorded in the authorized product data 212.

Further, in one embodiment, in order to enhance an anti-counterfeiting identification of the fabric 30, step 51 of the method 50 of the invention further includes sub-step 511: photographing a part of the fabric 30 with the anti-counterfeiting feature 32 to generate a plurality of fabric images 202 waiting verifying in different angles, sampling the plurality of fabric images 202 waiting verifying to generate the planar image optical feature distribution information and the three-dimensional image optical feature distribution information, and recording the planar image optical feature distribution information and the three-dimensional image optical feature distribution information in the anti-counterfeiting feature information 214. The planar image optical feature distribution information provides colour distribution of the fabric 30 in a two-dimensional manner by performing image processing on the each fabric image 202 to be analyzed, and the three-dimensional image optical feature distribution information provides colour distribution of the fabric 30 in a three-dimensional manner based on the fabric images 202 to be analyzed. In this way, a user does not need to limit a photographing angle when verifying the fabric 30, and therefore verification by the user can be facilitated.

What is claimed is:

1. A method for verifying a product authenticity with fabric features, the method implemented by an electronic device and comprising steps of:
receiving at least one fabric partial image and performing image analysis on the at least one fabric partial image to determine a fabric body comprising at least one first yarn loop and an anti-counterfeiting feature composed of a plurality of second yarn loops, and analyzing an image optical feature distribution information from a part of the anti-counterfeiting feature after the anti-counterfeiting feature is determined, wherein at least two sub-yarns which form the plurality of second yarns randomly forms the image optical feature distribution information, and the at least two sub-yarns comprise image optical features not close to each other, respectively;
receiving a fabric serial number generated by operation of an input device; and
retrieving the fabric serial number or the image optical feature distribution information to find a authorized product data correlated therewith, the authorized product data including an authorized product serial number and an anti-counterfeiting feature information of an authorized product, which are provided to comparing with the fabric serial number and the image optical feature distribution information; wherein providing an authorized product prompt information if the authorized product serial number and the anti-counterfeiting feature information of the authorized product are matched with the fabric serial number and the image optical feature distribution information; and wherein providing a counterfeit prompt information if the authorized product serial number and the anti-counterfeiting feature information of the authorized product are not matched with the fabric serial number and the image optical feature distribution information.

2. The method for verifying a product authenticity with the fabric features as claimed in claim 1, wherein the method further comprises photographing a fabric waiting verifying by a camera device to generate the at least one fabric partial image.

3. The method for verifying a product authenticity with the fabric features as claimed in claim 2, wherein the method further comprise receiving the at least one fabric partial image obtained from the fabric waiting verified, and inducting the anti-counterfeiting feature in the at least one fabric partial image via an image similarity analysis.

4. The method for verifying a product authenticity with the fabric features as claimed in claim 3, wherein the method further comprises obtaining at least two partial feature colour distribution information from the authorized product data, analyzing colour of the image optical feature distribution information to generate at least two feature colour distribution information which are the same as or similar to the at least two partial feature colour distribution information, respectively, and comparing each feature colour distribution information with the partial feature colour distribution information correlated thereto.

5. The method for verifying a product authenticity with the fabric features as claimed in claim 1, wherein the authorized product data is stored in a cloud server.

6. The method for verifying a product authenticity with the fabric features as claimed in claim 5, wherein the cloud server is implemented by blockchain storage.

7. The method for verifying a product authenticity with the fabric features as claimed in claim 2, wherein the anti-counterfeiting feature information of the authorized product includes a planar image optical feature distribution information and a three-dimensional image optical feature distribution information, and the method further comprises receiving a plurality of fabric partial images obtained from the fabric waiting verifying, retrieving the image optical feature distribution information from the anti-counterfeiting feature in the plurality of fabric partial images, and sampling a three-dimensional image optical feature distribution information to be verified for comparing with the three-dimensional image optical feature distribution information.

8. The method for verifying a product authenticity with the fabric features as claimed in claim 1, wherein the authorized product prompt information includes at least one of a product information, a brand manufacturer, a manufacturing country, a first point-of-sale, a location of an anti-counterfeiting feature, a fabric image of the anti-counterfeiting feature, and the authorized product serial number.

9. A method for establishing an authorized product data with fabric features, comprising steps of:
generating at least one fabric image to be analyzed by photographing a part of a fabric with an anti-counterfeiting feature, wherein the fabric comprises a fabric body comprising at least one first yarn loop and the anti-counterfeiting feature composed of a plurality of second yarn loops, and image optical features of the at least one first yarn loop is not close to image optical features of the plurality of second yarn loops;
performing image analysis on the second yarn loops in the at least one fabric image to generate an image optical distribution feature, wherein the image optical distribution feature is randomly generated by at least two sub-yarns, and at least two sub-yarns comprise image optical features not close to each other, respectively; and
recording the image optical distribution feature as an anti-counterfeiting feature information of an authorized product, and storing the anti-counterfeiting feature information in correlation with an authorized product serial number to generate an authorized product data.

10. The method for establishing the authorized product data with the fabric features as claimed in claim 9, wherein the at least two sub-yarns belong to a same colour hue in a natural colour system and are separated by at least three colour levels apart.

11. The method for establishing the authorized product data with the fabric features as claimed in claim 9, wherein colours of the at least two sub-yarns are not absolute white, absolute black, or gray mixed with absolute white and absolute black in proportion.

12. The method for establishing the authorized product data with the fabric features as claimed in claim 9, wherein the at least two sub-yarns are not reflective yarns.

13. The method for establishing the authorized product data with the fabric features as claimed in claim 9, wherein the authorized product serial number is a serial number or the authorized product serial number is defined by a brand owner.

14. The method for establishing the authorized product data with the fabric features as claimed in claim 13, wherein the authorized product data includes a first point-of-sale data, and the first point-of-sale data is generated after the fabric is first sold at a sales location.

15. The method for establishing the authorized product data with the fabric features as claimed in claim 14, wherein the method further comprises photographing a part of the fabric with the anti-counterfeiting feature to generate a plurality of fabric images waiting verifying in different angles, sampling the plurality of fabric images waiting verifying to generate a planar image optical feature distribution information and a three-dimensional image optical feature distribution information, and recording the planar image optical feature distribution information and the three-dimensional image optical feature distribution information in the anti-counterfeiting feature information.

16. The method for establishing the authorized product data with the fabric features as claimed in claim 9, wherein the method further comprises analyzing colour of the image optical distribution feature to generate at least two partial feature colour distribution information, and recording the at least two partial feature colour distribution information in the authorized product data.

17. The method for establishing the authorized product data with the fabric features as claimed in claim 9, wherein the authorized product data further includes a first point-of-sale data, and the first point-of-sale data is generated after the fabric is first sold at a sales location.

18. The method for establishing the authorized product data with the fabric features as claimed in claim 9, wherein the method further comprises photographing a part of the fabric with the anti-counterfeiting feature to generate a plurality of fabric images to waiting verifying in different angles, sampling the plurality of fabric images waiting verifying to generate a planar image optical feature distribution information and a three-dimensional image optical feature distribution information, and recording the planar image optical feature distribution information and the three-dimensional image optical feature distribution information in the anti-counterfeiting feature information.
